(19) United States
(12) Patent Application Publication
(10) Pub. No.: US 2018/0335898 A1
(43) Pub. Date: Nov. 22, 2018

(54) Electronic device and item selection method using gesture input

(71) Applicant: Edward Lau, Markham (CA)

(72) Inventor: Edward Lau, Markham (CA)

(21) Appl. No.: 15/598,350

(22) Filed: May 18, 2017

(51) Int. Cl. G06F 3/0482; G06F 3/01; G06F 3/0488

(52) U.S. Cl. CPC G06F 3/0482; G06F 3/04883; G06F 3/017

(57) ABSTRACT

An electronic device utilizes gesture input and an item selection method to improve selection speed and accuracy. An item of an array of items may represent, for example and without limitation, a typing character, an icon that triggers a corresponding routine, or a subset of items. A processor of the electronic device passes gesture navigation input to an item selection routine. The item selection routine converts gesture navigation input to a standard, magnitude independent pointer. The item selection routine then uses the standard point data to select a desired item from the array of items. Since the selection is not determined by the exact direction and magnitude of the gesture input, selection accuracy can be enhanced. By employing the item selection method, item selection traverse paths can be cycled within a confined sensing region; it can improve the selection speed and make it suitable for small-sized devices.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

### 1. Field

The disclosed and claimed concept relates to computer techniques, specifically to electronic device and item selection method using gesture input.

### 2. Description of Related Art

Item selection for many electronic devices is slow and error-prone due to their physical limitation. U.S. Pat. No. 9,529,530 to Applicant disclosed an electronic device and gesture input method to select a desired item from a plurality of items. The present invention disclosed an enhanced item selection method for selecting a desired item from an array of items using gesture input. The present item selection method uses new rules and conditions to shorten the number of navigation inputs and improve the selection speed.

### SUMMARY OF THE INVENTION

The present invention relates to an electronic device and item selection method using gesture input. An electronic device comprises a housing upon which are disposed an input apparatus, an output apparatus, and a processor apparatus. The input apparatus provides input to the processor apparatus. The processor apparatus provides output signals to the output apparatus.

The output apparatus includes a display that provides visual output. The display comprises an array of items. An item of the array may represent, for example and without limitation, a typing character, an icon that triggers the processor to execute a corresponding routine, or a subset of items.

A gesture input device of the input apparatus captures gesture signals, for example and without limitation, gesture of user finger, from one or more sensing regions, then transfers the navigational, selection, and other input data to a processor of the processor apparatus.

The processor passes the gesture navigation input to an item selection routine. The item selection routine interprets the gesture navigation input as vertical and horizontal movement, respectively. If one of the vertical and horizontal movements has a magnitude greater than the other, and the magnitude is greater than a predetermined threshold, the movement having the greater magnitude would be employed by the item selection routine and classified as a vertical standard pointer or horizontal standard pointer. The item selection routine then uses the standard pointer data to select a desired item from an array of items.

The present item selection method allows user to select the desired item in a smooth continuous movement, and shorten the number of navigation inputs when an initially selected item is not set at a corner of the array.

By employing the present item selection method, selection traverse paths can be cycled within a small confined region; it can improve the selection speed and make it suitable for small-sized devices. By memorizing the standard pointer patterns, user can select a desired item without looking at the display.

### BRIEF DESCRIPTION OF THE DRAWINGS

A full understanding of the disclosed and claimed concept can be obtained from the following description, read in conjunction with the accompanying drawings:

FIG. 1 is an embodiment of electronic device that utilizes gesture input to select a desired item from an array of items;

FIG. 2 is a schematic depiction of the electronic device of FIG. 1;

FIG. 3 depicts exemplary traverse paths for selecting a desired item from an array of items where the items are arranged in one-dimensional horizontal array;

FIG. 4 depicts exemplary traverse path for selecting a desired item from an array of items where the items are arranged in two-dimensional array; and

FIG. 5 shows an embodiment of an input apparatus and its traverse path for selecting a desired item from an array of items.

### DETAILED DESCRIPTION

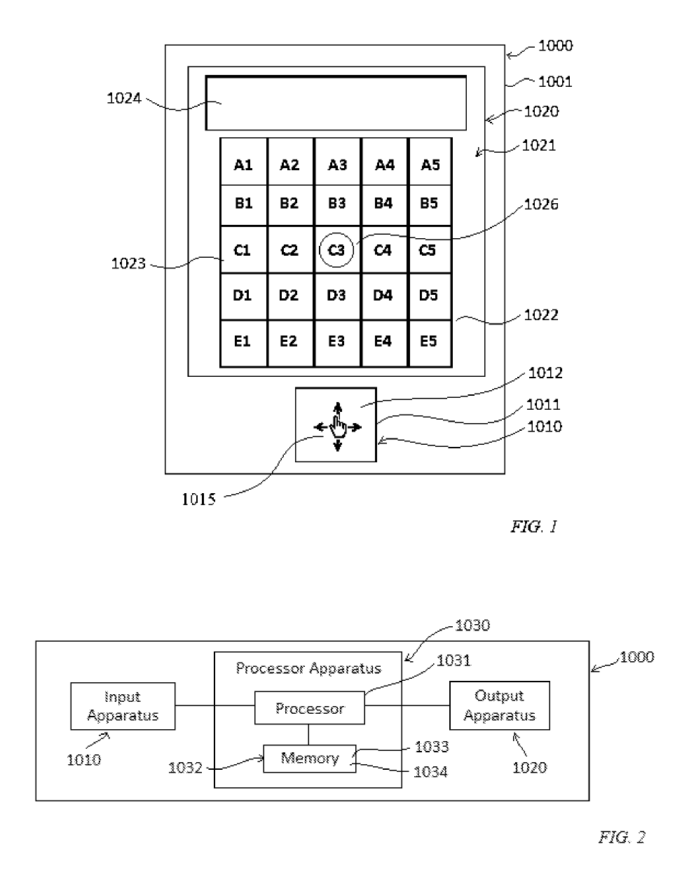

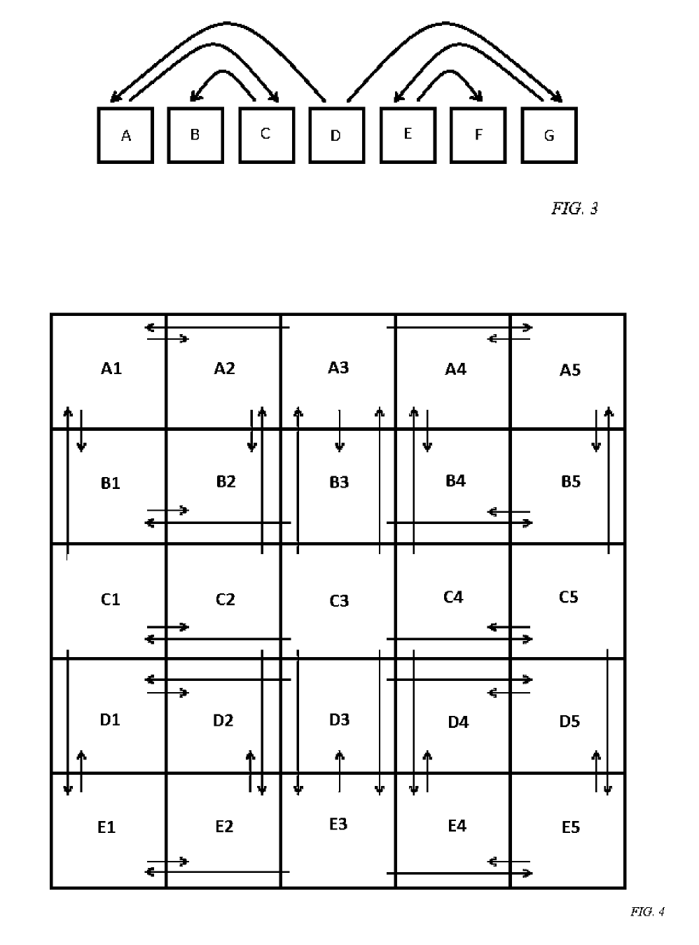

An electronic device 1000 in accordance with the disclosed and claimed concept is indicated generally in FIG. 1 and is depicted schematically in FIG. 2. As shown in FIG. 1, the electronic device 1000 comprises a housing 1001 upon which are disposed an input apparatus 1010, an output apparatus 1020, and a processor apparatus 1030. The input apparatus 1010 provides input to the processor apparatus 1030. The processor apparatus 1030 provides output signals to the output apparatus 1020.

As shown in FIG. 2, the processor apparatus 1030 comprises a processor 1031 and a memory 1032. The processor 1031 may be, for example and without limitation, a microprocessor that interfaces with the memory 1032. The memory 1032 can be any one or more of a variety of types of internal and/or external storage media such as, and without limitation, RAM, ROM, EPROM(s), EEPROM(s), FLASH, and the like, that provides a storage register for data storage such as in the fashion of a machine readable medium or an internal storage area of a computer, and can be volatile memory or nonvolatile memory. The memory 1032 has stored an item selection routine 1033 that are executable on the processor 1031. The memory 1032 has further stored a history log 1034 that records data of items that has been occupied.

With reference to FIG. 1, the input apparatus 1010 of the first embodiment of the electronic device 1000 includes a gesture input device 1011. The gesture input device 1011 uses, for example and without limitation, one or more tactile sensors or optical sensors, to capture gestural signals, for example and without limitation, gesture of user finger 1015, from one or more sensing regions 1012. A sensing region 1012 is a specific boundary area where the gesture input device 1011 only captures the key gesture signals that are obtained within that confined area. Once the gesture input device 1011 captured gesture signals from the sensing region 1012, the gesture input device 1011 transfers the navigational, selection, and other input data to the processor apparatus 1030.

With reference to FIG. 1, the output apparatus 1020 of the first embodiment of the electronic device 1000 includes a display 1021 that provides visual output. The display 1021 comprises an array of items 1022, and a text area 1024. An item 1023 of the array 1022 may represent, for example and without limitation, a typing character, an icon that triggers the processor to execute a corresponding routine, or a subset of items. Currently selected item 1026 can be indicated by, for example and without limitation, having an indicator highlighting it.

In accordance with the disclosed and claimed concept, when the processor 1031 receives gesture navigation input from the gesture input device 1011, the processor 1031 passes the gesture navigation input to the item selection routine 1033. The item selection routine 1033 interprets the gesture navigation input as vertical and horizontal movement, respectively. If one of the vertical and horizontal movements has a magnitude greater than the other, and the magnitude is greater than a predetermined threshold, the movement having the greater magnitude would be employed by the item selection routine 1033 and classified as a vertical standard pointer or a horizontal standard pointer.

The item selection routine 1033 uses direction of standard pointers to select an item from the array; as long as the magnitude of the gesture navigation movement is greater than a predetermined threshold, the actual magnitude does not affect the item selection, thus enhancing the accuracy of item selection. The selection criteria comprise the standard pointer input and the history of previously occupied items.

To select a new desired item, the processor 1031 initializes the item selection routine 1033. The item selection routine 1033 clears history log 1034 data and assigns a predetermined item as an initially selected item and set the item as currently selected item. The item selection routine 1033 then inserts the data of the currently selected item into the history log 1034. If the currently selected item is the desired item, the item selection routine 1033 assigns the currently selected item as final item; otherwise, user generates a new gesture navigation input and the item selection routine 1033 uses the following procedures to select the desired item:
1) Converting gesture navigation input to a standard pointer indicating the direction of navigation. If the standard pointer direction is horizontal, from the currently selected item, in the direction of that standard pointer, select the furthest unoccupied item from the array that has no occupied item column in between. If the standard pointer direction is vertical, from the currently selected item, in the direction of that standard pointer, select the furthest unoccupied item from the array that has no occupied item row in between.
2) Storing the newly selected item data to the history log 1034. If the newly selected item is the desired item, assign it as final item; otherwise, repeat generating another new gesture navigation input that converts to a new standard pointer that is not in the direction of the last standard pointer, until the desired item is selected.

The present item selection method allows user to select a desired item from an array of items in a smooth continuous movement, and shorten the number of navigation inputs when the initially selected item is not set at a corner of the array.

The present item selection method can be applied to one-dimensional array, two-dimensional array, or three-dimensional array. FIG. 3 depicts exemplary traverse paths for selecting a desired item from an array of items where the items are arranged in one-dimensional horizontal array:
1) Assigns an item as an initially selected item. In this case item “D” is selected.
2) If item “D” is not the desired item, the next qualified options are item “A” and “G”. User can point left to select item “A” or point right to select item “G”.
3) If user point left and item “A” is not the desired item, the next qualified option is item “C”. Item “G” is not an qualified option since standard pointer direction from item “A” to “G” is horizontal and item “D” has been occupied, any item in or beyond item “D” column is not an qualified option. User can point right to select item “C”.
4) If user points right and item “C” is not the desired item, the next qualified option is item “B”. User can point left to select item “B”.
5) Item “B” is the last qualified item.

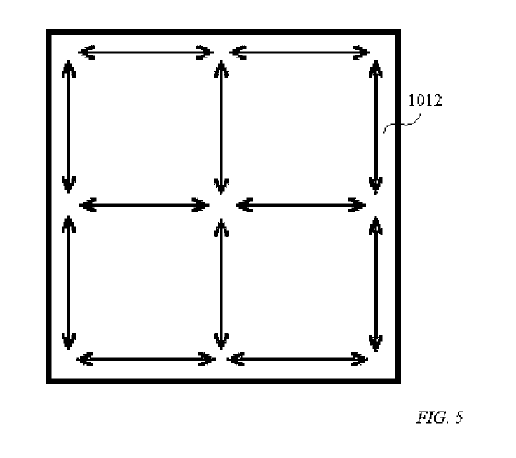

FIG. 4 depicts exemplary traverse path for selecting a desired item from an array of items where the items are arranged in two-dimensional array:
1) Assigns an item as an initially selected item. In this case item “C3” is assigned.
2) If item “C3” is not the desired item, the next qualified options are item “C1”, “C5”, “A3”, and “E3”. User can point left to select item “C1”, point right to select item “C5”, point up to select item “A3”, or point down to select item “E3”.
3) If user points left and item “C1” is not the desired item, the next qualified options are item “E1”, “A1”, and “C2”. Item “C2” is an qualified option instead of item “C5” since standard pointer direction from item “C1” to item “C2” or “C5” is horizontal and item “C3” has been occupied, any item in or beyond item “C3” column is not an qualified option. User can point down to select item “E1”, point up to select item “A1”, or point right to select item “C2”.
4) If user points up and item “A1” is not the desired item, the next qualified options are item “A2” and “B1”. Item “A2” is an qualified option instead of item “A5” since standard pointer direction from item “A1” to item “A2” or “A5” is horizontal and item “C3” has been occupied, any item in or beyond item “C3” column is not an qualified option. Item “B1” is an qualified option instead of item “E1” since standard pointer direction from item “A1” to item “B1” or “E1” is vertical and item “C3” has been occupied, any item in or beyond item “C3” row is not an qualified option. User can point down to select item “B1”, or point right to select item “A2”.
5) If user point down and item “B1” is not the desired item, the next qualified option is item “B2”. Item “B2” is an qualified option instead of item “B5” since standard pointer direction from item “B1” to item “B2” or “B5” is horizontal and item “C3” has been occupied, any item in or beyond item “C3” column is not an qualified option. User can point right to select item “B2”.
6) Item “B2” is the last qualified item.

An exemplary embodiment of the gesture input device is shown in FIG. 5. The standard pointers with respect to the sensing region of this gesture input device consists of vertical pointers and horizontal pointers. As shown in FIG. 5, traverse paths for selecting item are confined inside the sensing region 1012.

By employing the present item selection method, selection traverse paths can be cycled within a small confined region; it can improve the selection speed and make it suitable for small-sized devices. By memorizing the standard pointer patterns, user can select a desired item without looking at the display.

While specific embodiments of the disclosed and claimed concept relates generally to electronic device and item selection method using gesture input have been described in detail, it will be appreciated by those skilled in the art that various modifications and alternatives to these details could be developed. Accordingly, the particular arrangements disclosed are meant to be illustrative only and not limiting as to the scope of the disclosed and claimed concept which is to be given the full breadth of the claims appended and any and all equivalents thereof.

I claim:

1. A method for a system that selects a desired item from an array of items based on gesture navigation inputs, comprising:
listing said array of items;
assigning a predetermined item from said array as an initially selected item and set said item as currently selected item;
storing data of said currently selected item in a history log of occupied items;
if said currently selected item is said desired item, assign said currently selected item as final item;
if said currently selected item is not said desired item, generate a new gesture navigation input;
converting said gesture navigation input to a standard pointer indicating the direction of navigation;
if said standard pointer direction is horizontal, from said currently selected item, in the direction of said standard pointer, select the furthest unoccupied item from said array that has no occupied item column in between;
if said standard pointer direction is vertical, from said currently selected item, in the direction of said standard pointer, select the furthest unoccupied item from said array that has no occupied item row in between;
storing data of said newly selected item in said history log of occupied items;
if said newly selected item is said desired item, assign it as final item;
if said newly selected item is not said desired item, repeat generating another new gesture navigation input that converts to a new standard pointer that is not in the direction of the last standard pointer, until said desired item is selected.

2. The method of claim 1 wherein said display means further displaying said array of items.

3. The method of claim 1 wherein said array of items are arranged in one-dimension.

4. The method of claim 1 wherein said array of items are arranged in two-dimensional array.

5. The method of claim 1 wherein said array of items are arranged in three-dimensional array.

6. An apparatus for selecting a desired item from an array of items based on gesture navigation inputs, comprises:
a display for displaying said array of items and indicates a currently selected item;
a memory for storing data of said currently selected item in a history log of occupied items;
a sensor means for receiving gesture navigation inputs;
and
a controller, which will:
list said array of items;
assign a predetermined item from said array as an initially selected item and set said item as currently selected item;
store data of said currently selected item in a history log of occupied items;
if said currently selected item is said desired item, assign said currently selected item as final item;
if said currently selected item is not said desired item, generate a new gesture navigation input;
convert said gesture navigation input to a standard pointer indicating the direction of navigation;
if said standard pointer direction is horizontal, from said currently selected item, in the direction of said standard pointer, select the furthest unoccupied item from said array that has no occupied item column in between;
if said standard pointer direction is vertical, from said currently selected item, in the direction of said standard pointer, select the furthest unoccupied item from said array that has no occupied item row in between;
store data of said newly selected item in said history log of occupied items;
if said newly selected item is said desired item, assign it as final item;
if said newly selected item is not said desired item, repeat generating another new gesture navigation input that converts to a new standard pointer that is not in the direction of the last standard pointer, until said desired item is selected.
